(19) United States
(12) Patent Application Publication
(10) Pub. No.: US 2012/0136517 A1
(43) Pub. Date: May 31, 2012

(54) Power generation method and apparatus

(76) Inventor: Peter Bauer, St. Joseph, IN (US)

(21) Appl. No.: 12/927,905

(22) Filed: Nov. 29, 2010

(51) Int. Cl. B60W 20/00; H02J 7/34

(52) U.S. Cl. 701/22; 307/46; 180/65.245; 180/65.265; 903/905; 903/906; 903/907; 903/930

(57) ABSTRACT

A method and apparatus is provided for obtaining improved power generation efficiency by operating the primary power source, such as an ICE, only at the most efficient operating modes for a given engine, and simultaneously supplementing the power provided by the ICE with additional power stored in an accumulator, such as an ultra capacitor, as the load demands would otherwise cause that ICE to operate outside of the more efficient operating modes. In the case of a hybrid electric vehicle, the present invention would use banks of ultra-capacitors instead of batteries not just to start the ICE but also to supplement the electric power available for wheel drive motors when the ICE is in operation. According to the present invention, a control device would maintain the ICE at specific operational modes, either off, idle, or specific fuel efficient operating conditions over the entire range of vehicle operation. When the vehicle needs more power than the ICE would otherwise provide at a given operational mode, the controller would enable the additional power to be drawn from the ultracapacitors until such time as the ICE could be efficiently switched to a different mode. Excess power from the ICE when at an efficient operating mode would be used to recharge the ultracapacitors.

### BACKGROUND AND SUMMARY OF THE INVENTION

The present invention relates generally to methods and apparatus for generating power, and more specifically, for more efficiently providing vehicular motive power in a hybrid electric vehicle format.

A wide variety of power generation systems have been known and used. However, those power sources typically have variations in their level of efficiency, depending upon how the power source is operating at a given point in time. For example, with internal combustion engines (often referred to as “IC engines” or “ICEs”) the fuel efficiency varies according to several factors, such as the operating speed and torque of the engine. Further, the loads which are applied to many power sources can vary over time, and that load can affect the efficiency of the power source. With an ICE in a vehicle, for example, the load can vary according to the vehicle cargo weight, acceleration, hill climbing, and vehicle speed. In general and for example, the most efficient operating condition or mode of operation of a given ICE may be at approximately one half of its maximum power output.

Improving the efficiency of power sources is desirable for a number of well-known reasons. Various methods and apparatus have been used in attempting to improve that efficiency, but each of those has been subject to certain drawbacks and limitations. Thus, such improvement has remained a long-felt need.

Motor vehicles have employed portable power sources, such as internal combustion engines, for many years. Electrical storage batteries have been used in motor vehicles to assist in starting the ICE. Recently, attempts have been made to improve the fuel efficiency of vehicles by using batteries not just to start the ICE but also to power the vehicle at low speeds and/or for short distances of travel. Outside of that operating range, the batteries are not the sole power source and the ICE is turned on to power the vehicle and charge the batteries in the normal matter of an ICE, albeit sometimes through electric drive motors for the individual wheels rather than a mechanical transmission linkage such as is found in conventional vehicles.

However, such hybrid electric power systems have certain drawbacks. Typically, the batteries needed for the extra power have required significant additional weight to be added to the vehicle load. Also, the thermal energy losses in the batteries, particularly as they are being repeatedly charged and discharged over time, can be significant. Further, batteries often have a relatively short deep-draw cycle life, meaning they can only be fully discharged and charged a few hundred times before wearing out. Also, batteries that are cost effective for the consumer market often do not have the power needed for the vehicle over long periods of time and/or at high speeds. Furthermore, having batteries as energy storage devices can limit the amount of regenerative braking that can be applied. Batteries also may not be able to take excess power surges as during sudden ICE load changes, such as with sudden acceleration or sudden braking. Finally, with current battery technology, it can be difficult to maintain the ICE in its optimal operating regime or modes of operation. Accordingly, at the present time hybrid electric vehicles have not been in widespread use and are more costly to produce than prior vehicles powered by only an ICE.

An objective of the present invention is to provide improved efficiency, particularly fuel efficiency, in power generation systems, and particularly those used in motor vehicles. The present invention achieves this improved efficiency by operating the primary power source, such as an ICE, only at the more efficient modes for a given engine, and then supplementing the power with additional power stored in an accumulator, such as an ultra capacitor, as the load demands would otherwise cause that engine to operate outside of the more efficient modes. In the case of a hybrid electric vehicle, the present invention would use banks of ultra-capacitors instead of batteries not just to start the ICE but also to supplement the electric power available for wheel drive motors when the ICE is in operation. According to the present invention, a control device would maintain the ICE at specific operational conditions, either off, idle, or specific fuel efficient operating speeds and torques over the entire range of vehicle operation. When the vehicle needs more power than the ICE would otherwise provide at a given operational mode, the controller would enable the additional power to be drawn from the ultracapacitors until such time as the ICE could be efficiently switched to a different mode. Excess power from the ICE when at an efficient operating mode would be used to recharge the ultracapacitors. The control device would be used to maintain a sufficient level of energy in the ultracapacitors as an energy accumulator.

Other objects, advantages, and novel features of the present invention will become readily apparent from the following drawings and detailed description of preferred embodiments.

### BRIEF DESCRIPTION OF THE DRAWINGS

FIG. 1 shows a schematic view of a preferred embodiment of the present invention as adapted for use in a motor vehicle.

FIG. 2 shows a schematic view of a control architecture suitable for the present invention.

FIG. 3 shows a schematic view of power flow in a preferred embodiment of the present invention.

FIG. 4 shows a schematic view of the ICE control device—ICE interaction in a preferred embodiment of the present invention.

FIG. 5 shows a flow chart for the programming of a control device of a preferred embodiment of the present invention.

FIG. 6 is the specifications chart of FIG. 5.

### DETAILED DESCRIPTION OF PREFERRED EMBODIMENTS

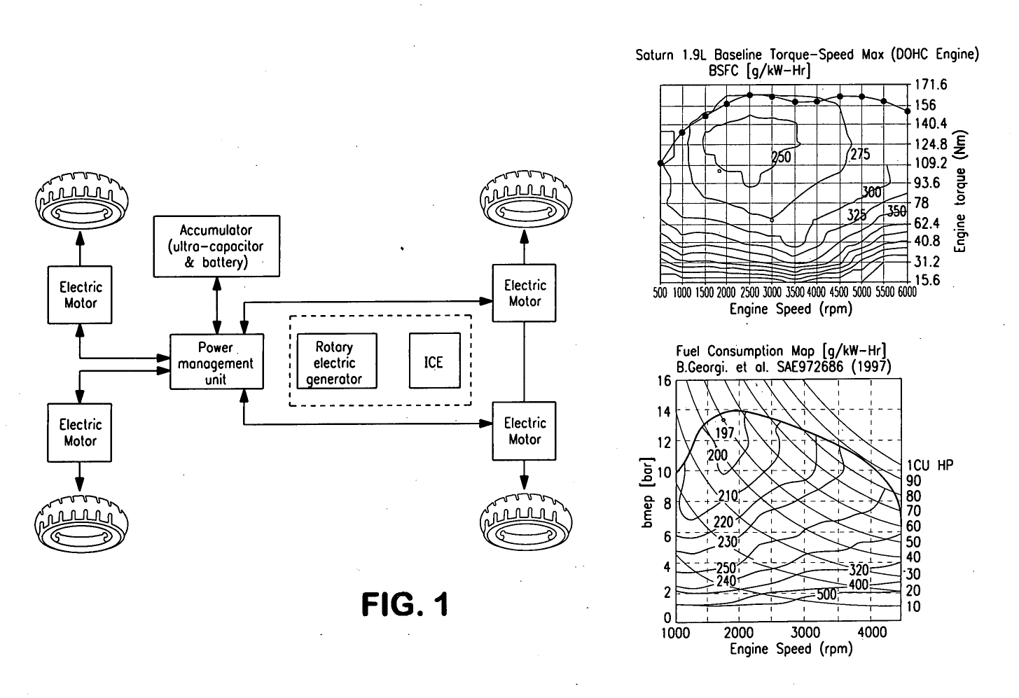

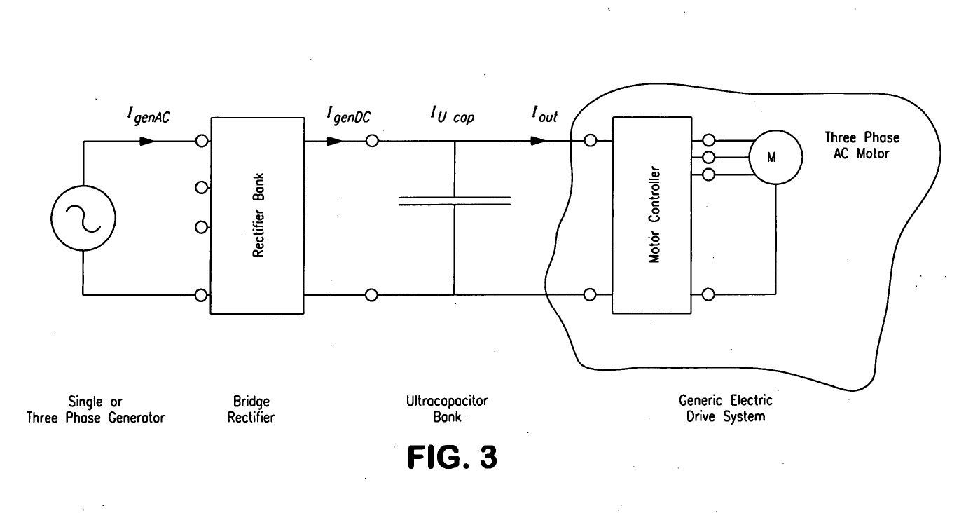

In FIG. 1, the vehicle is driven by electric motors associated with each wheel. As used herein, “power” can be best understood as a measure of the energy used or generated over time. Electric power is provided to those motors via a power management unit that addresses the needs of each motor according to vehicle operational parameters in a conventional manner. The primary source of electric power to the power management unit is provided by an ICE coupled to a rotary electric generator, also in a conventional manner. However, incident to the present invention, an accumulator also supplies electric power to the power management unit. In especially preferred embodiments, that accumulator includes both a conventional battery and an ultracapacitor array or bank. The battery can be used to keep the minimum needed charge on the ultracapacitor when the vehicle is in storage, and/or to provide the ICE start-up cranking power through a converter. Alternatively, a shore-based power supply (such as by plugging into a household power supply) could be used to keep the minimum needed charge on the ultracapacitor when the vehicle is in storage. Also, in a preferred embodiment, the rectifier output, the ultracapacitor bank, and the electric motor controllers are in a parallel configuration, such as shown in FIG. 3.

The fundamental principle upon which the present invention is based is that certain power generation systems have large variations in efficiency depending upon the way they operate. This is abundantly clear in the case of the fuel efficiency characteristics of ICEs, as shown in the charts of FIG. 1. It is more efficient to run the ICE at or around its lowest “brake specific fuel consumption” or “bsfc” range as long as possible and, when substantially more power is needed for high loads and/or long term operation, to then shift the ICE into one or two high power modes which are also the most fuel efficient among the higher speeds. Simply stated, running the ICE at the most fuel efficient operating conditions saves fuel over either continuously varying the ICE operating conditions or continuously operating the ICE far away form the bsfc optimum. To make up for the extra power required for vehicle operation during these instantaneous power need changes, the present invention would cause the electrical power of the ultracapacitors to be discharged as a supplement. Depending upon the particular mode of operation, this supplement would be in place of ICE based electric power, or added to the ICE based electric power, or withdrawn from the ICE based electric power (to recharge the ultracapacitors).

The ICE, mechanically coupled with, for example, a brushless single or three phase generator in a conventional manner, can repeatedly charge one or more ultracapacitor banks through high power AC to DC converters or rectifiers or other devices suitable for that purpose. The ultracapacitor charge is monitored and maintained at desired levels through an ICE controller device to stay between lower and upper voltage bounds, according to the needs of a given vehicle's operations. That control device preferably also switches the ICE between off, idle, and bsfc optimal operating regimes or modes of operation.

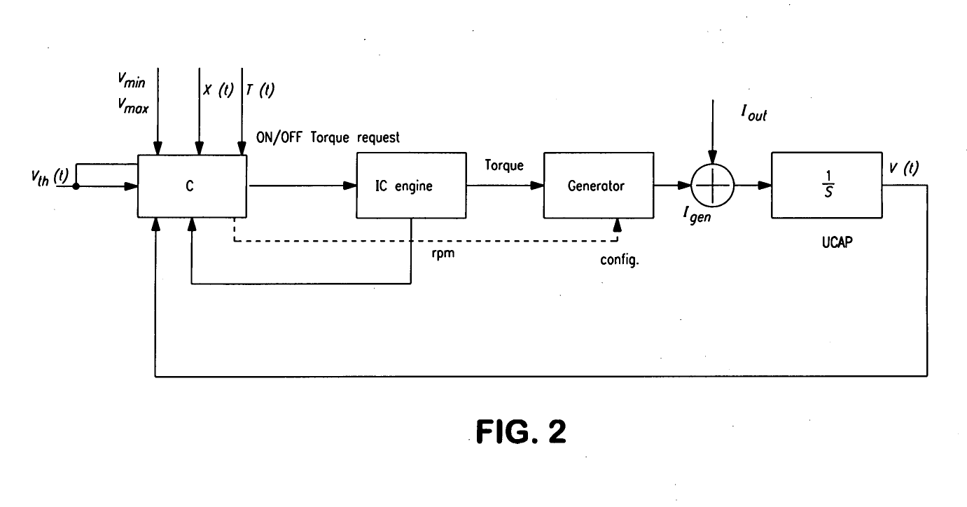

In FIG. 2, T(t) represents the ICE temperature, x(t) represents the distance traveled, Vmin/max represents the minimum and maximum voltage needed, Vth(t) represents the lower voltage threshold, and I represents the current.

In preferred embodiments, the construction would include electrically coupling the output of the generator through one or more power rectifiers to an ultracapacitor bank. That bank should be large enough to handle the maximum electric motor controller/power management unit input voltage and the short term maximum power requested by the vehicle. An ultracapacitor is considered to be an electrical capacitor with a storage capacity at least one farad of charge. An ultracapacitor bank preferably includes a series connection of several individual ultracapacitor modules. The ultracapacitors can be arranged either as a single bank, several banks in parallel, or by using parallel configurations of cascades of bank (especially where high power applications are intended). The output of the ultracapacitor bank(s) is connected, for example, in parallel to the conventional electric motor controller at the power management unit, as shown in FIG. 3.

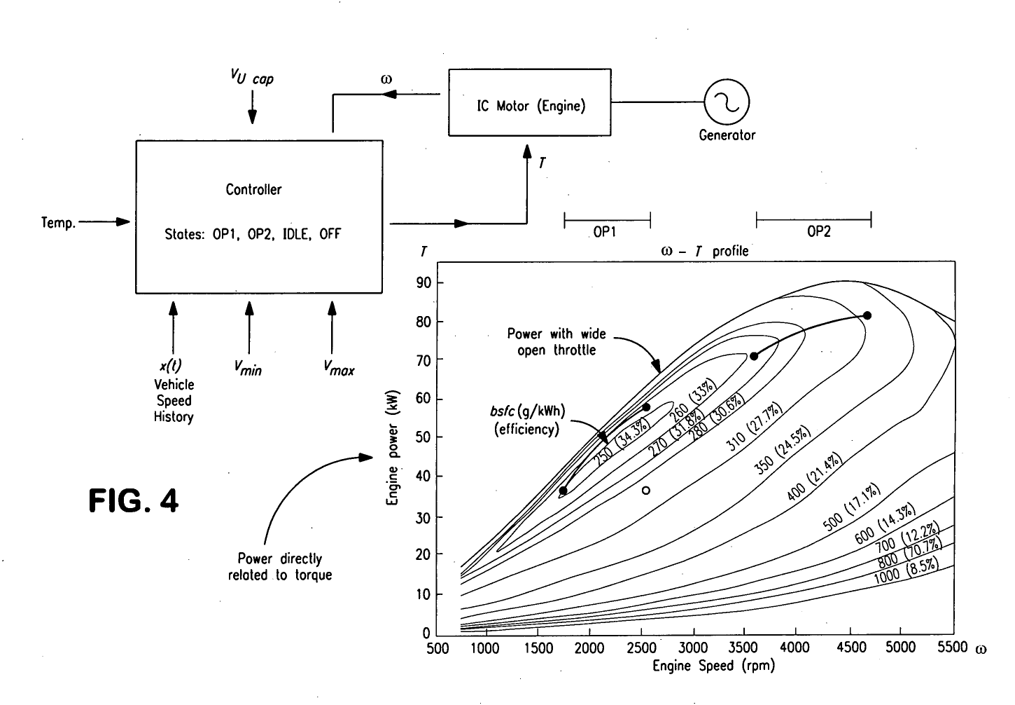

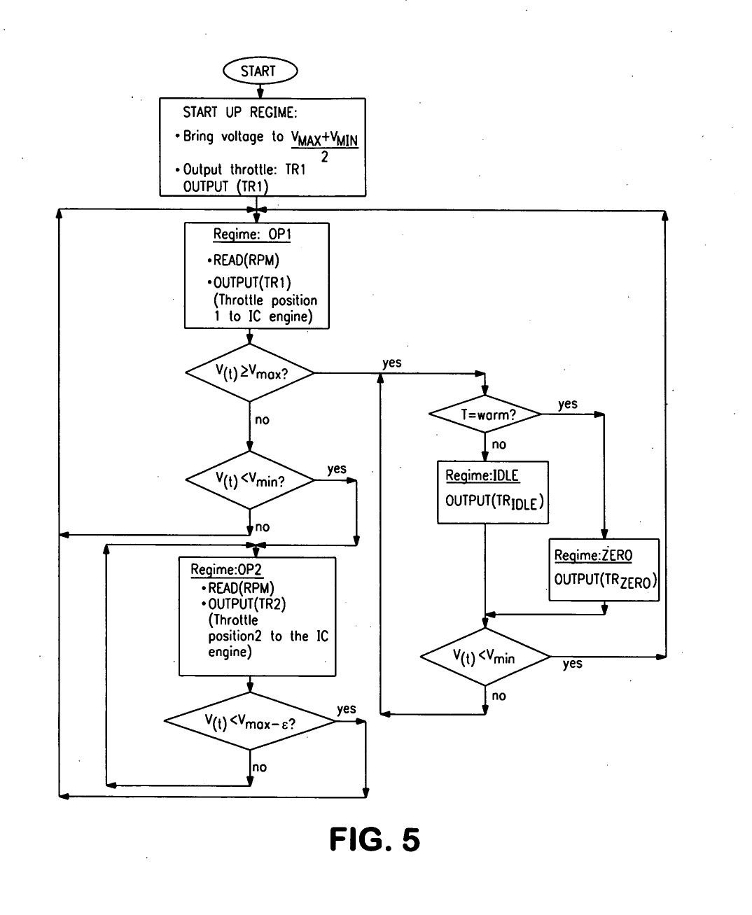

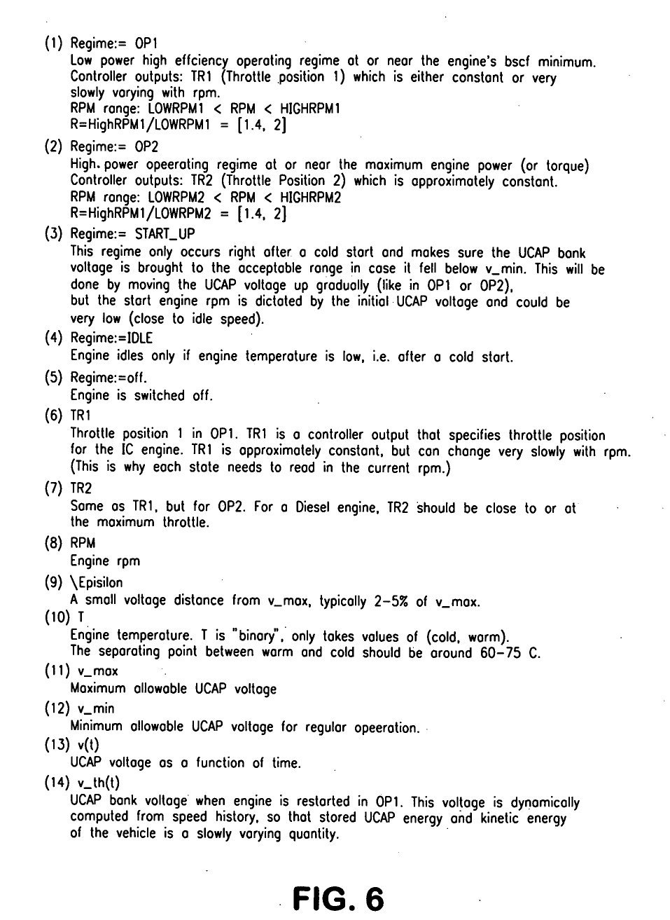

As shown in FIG. 4, the present invention includes a control device connected between the ultracapacitors, the ICE, and various engine speed sensors and other vehicle data sources. The control device steps the ICE through certain specific operating conditions. The control device acquires vehicle data from various conventional sources in order to optimize power generation efficiency according to particular programming selected for that vehicle and its needs. A representative programming flow chart for the control device of is shown in FIG. 5, as explained by the specifications chart of FIG. 6. Control device function of the present invention is a supplement to the conventional electric motor controllers in electric vehicles so as to permit the inventive use of ultracapacitors in those vehicles. It is expected that both type controllers can be physically integrated into a power management unit.

In the preferred embodiments described above, the present invention can significantly increase the fuel efficiency of motor vehicles. This invention achieves that with a minimum of weight and cost and provides a durable, robust hybrid electric power generation unit with a simplified construction. However, alternative embodiments of the present invention can also be used as a range extender for conventional (battery based) electric vehicles. In addition, the inventive concept of ultracapacitors can be used to extend and improve hybrid electric vehicle power generation systems based upon fuel cells or other chemical energy conversion processes. Further, the present invention can be applied to non-vehicular uses, such as stand-by generators and power generators for construction work. Other embodiments and applications of the present invention will be readily apparent to those of ordinary skill in the art from the information provided above. Accordingly, the spirit and scope of the present invention are limited only by the scope of the claims listed below.

What is claimed is:

1. A power generation system comprising:
a power source which has variations in its levels of efficiency during operation,
that power source creating power at its output during operation,
a load which receives the output power, that load having variations in its power demands,
an energy accumulator connected to the output of the power source, and
a controller device connected to the power source and the energy accumulator, the controller device serving to operate the power source at its more efficient levels regardless of the variations in the power demands of the load and to supplement the power with power from the energy accumulator.

2. The power generation system of claim 1 wherein:
the output power that the power source produces is electrical power, and
the energy accumulator contains a supply of electrical energy.

3. The power generation system of claim 2 wherein the energy accumulator is connected to the power source in a manner which recharges the energy accumulator with excess electrical power from the power source during operation of the power source.

4. The power generation system of claim 3 wherein:
the power source includes an internal combustion engine coupled to a rotary electrical generator, and
the energy accumulator is an electrical capacitor capable of storing a charge of at least one farad.

5. The power generation system of claim 4 wherein the energy accumulator is an ultracapacitor which is repeatedly charged and discharged so as to operate the internal combustion engine at optimum fuel efficiency during at least certain operational phases of that engine.

6. The power generation system of claim 5 further comprising:
a wheeled vehicle containing the system therein,
a plurality of electric motors connected to the power output for driving vehicle wheels, and
a vehicular control system for controlling the power demands of those electric motors in response to vehicle operator commands.
